(19) United States
(12) Patent Application Publication
(10) Pub. No.: US 2002/0069363 A1
(43) Pub. Date: Jun. 6, 2002

(54) System and method for data recovery and protection

(76) Inventor: Michael Lee Winburn, Indialantic, FL (US)

Correspondence Address: JOEL I ROSENBLATT, 445 11TH AVENUE, INDIALANTIC, FL, 32903, US

(21) Appl. No.: 09/730,049

(22) Filed: Dec. 5, 2000

(51) Int. Cl. G06F 12/16; H04B 1/74

(52) U.S. Cl. 713/200; 711/162; 714/6

(57) ABSTRACT

A protected data file currently in use is duplicated as an authentic backup file, while changing the current file's data appearance and separating the location of the authentic backup file from the original and current file, to camouflage its identity from an unauthorized intruder intending to modify or destroy the original file. A series of indica is generated and stored in a recovery address group or file. The indica represent the original current file and is used to reconstruct the authentic backup file and to write a restored file into the current protected data file. The recovery process may be initiated on a schedule or whenever the original current file is accessed or whenever an unauthorized use of the current file is detected and a comparison of the authentic backup file indicates the original current file has been modified. In this way, the authentic data saved from the original current file may be used to restore the protected data file as originally written and saved in the authentic backup.

### FIELD OF THE INVENTION

This invention relates in general to the protection of stored data and in particular to the detection of unauthorized modification or destruction of the authorized stored data and its recovery and restoration.

### BACKGROUND

Maintaining the integrity of stored data in any form is a critical part of data processing and transmission. Many techniques have been developed with the singular purpose of preventing unauthorized intrusion into protected data systems that are intended to be secure. The increase in the numbers of these techniques has been produced in part from the growing use of data processing and transmission in business transactions, popularly known as “e-commerce.” While one of the concerns in e-commerce transactions is the detection of an unauthorized intrusion, another equally important concern is maintaining the integrity of the stored data. When an intrusion, meaning any unauthorized access of data by entry without authority into a data system, has been detected, the next question asked is whether the intruder has modified or destroyed any of the data. In any case of unauthorized system intrusion, data integrity and authenticity are lost and cannot be restored unless the system can determine where the intruder was in the system and which data files or storage were accessible to the intruder or what modifications or changes were made.

Where data processing protection systems have been relying on encryption, personalization such as by passwords, or by scattering of the data through a data store randomly or by strict or intelligent algorithm, the intruder, once having reached all or part of the protected data, may have modified or destroyed the data without leaving an indication of the modification or the original and authorized authentic data. While data security systems or methods may detect the intrusion and determine whether the data modification or destruction was authorized, there is no method or system for safeguarding the authentic data or for verifying the data appearing in a protected file after an unauthorized intrusion is the same as the authorized data, or that an unauthorized modification has been made, or for recovery of the authentic data through an authentic backup file, or for camouflaging an authentic backup data file to hide it from access and destruction, using techniques to hide the data identity such as size change, content masking using encryption, name or location change or for using these data camouflaging techniques to reassemble the original authentic data to automatically recover the data after an intrusion.

### SUMMARY OF THE INVENTION

This invention is a system and method for protecting the authenticity of stored data by monitoring a protected data file to determine if any unauthorized change in the protected data file has occurred and, when the protected data file has been comprised, restoring the protected data file to its authentic contents through the use of an authentic backup file. For this description of the invention, the protected data file is called authorized protected data file when the protected data file is the original protected data file or the original protected data file is modified or accessed by an authorized modification or user. The protected data file is called the current protected data file when in the use of the invention, the protected data file is tested or compared with the authorized protected data file such as by a comparison with the authorized protected data file or representative indicia to determine if the protected data file is the same as the authorized protected data file or if there is a change in the current protected data file relative to the authorized protected data file.

The backup file containing the data contents of the authorized protected data file is called the authentic backup file. The indica used in the translation of the authorized protected data file to the authentic backup file and representing the authorized protected data file, is stored in a recovery data group, which may be a static file but according to the preferred embodiment and to add to the security of the authentic backup file, is stored in a recovery data group in active memory.

Protected data files are monitored such as for example, by sensed event or sensed time and by comparison of one or more selected indica of the current protected data file with respective one or more indicia corresponding to the last authorized protected data file and to the authentic backup file. Where the compared indicia for the current protected data file is inconsistent with the corresponding indicia saved from the last authorized protected data file, an indication is produced of an unauthorized change in the authorized protected data file and the authorized protected data file is restored by reconstructing the authorized protected data file from the authentic backup file and using it to replace the current protected data file. While monitoring current protected data files to determine any unauthorized event such as an intrusion or modification, the maintenance of file integrity in the event of any such unauthorized change to the current protected backup file requires the authentic backup file be used to replace the corrupted or suspect current protected data file and to restore the current protected data file to the restored copy of the authorized protected data file reconstructed from the authentic backup file and representing the last authorized copy of the current protected file and the authorized protected data file.

The invention uses the authorized last copy of the protected file, called the authorized protected data file, to produce an authentic backup file, utilizing a combination of camouflage techniques to hide the authentic backup file and shield it from unauthorized access or modifications and to preserve its integrity as the authentic representation of the authorized protected data file. Camouflaging, as shown in the preferred embodiment is by changing the relationship of the data in the authorized protected data file when it is translated to the authentic backup file to hide the relationship between the data in the authorized protected data file and the data in the authentic backup file and to prevent an intruder from using the relationship of the data in the authorized protected data file to find or recognize the location of any of authentic backup file or even of the recovery data group containing the recovery indicia for locating the authentic backup files and for use in restoring the last authorized copy of the authorized protected data file. By intruder is meant any unauthorized entry into a data system.

As shown and described in the Detailed Description of the Invention, an algorithm, such as for example any one way hash or other algorithm as would be known to those skilled in the art is used to produce from at least one attribute of the authorized protected data file, an identifier of the authorized protected data file. This identifier is stored and used to test the content of the current protected data file to determine if the current protected data file is the same as the authorized protected data file or has been changed without authorization. The identifier may be produced using one or more attributes of the authorized protected data file, in any combination of unique or non-unique attributes, as would be known to those skilled in the art. The identifier may be compared to a test identifier produced from a current protected data file on a scheduled time basis or on an event basis, as would be known to those skilled in the art. The comparison is used to determine if the current protected data file has been modified without authorization. Where the comparison of the identifier and test identifier indicates a difference in protected data file content, an indication of an unauthorized modification is produced and in response to that indication, the authentic backup file is retrieved to restore the authorized protected data file.

The authentic backup file is produced from the authorized protected data file by translating its size and content such as by compression and encryption and by changing its file name and location, to camouflage and hide its identify and relationship to the authorized protected data file. As would be known to those skilled in the art and without departing from the inventive principles disclosed herein, other techniques could be added to similarly camouflage the identify of the authentic backup file and its relationship to the authorized protected data file and to hide the identify or location of the authentic backup file, without departing from the disclosed principles of the invention.

In the preferred embodiment as shown and described herein, camouflaging of the authentic backup file is done hide the authentic backup file, to prevent access or its destruction or modification and to preserve its integrity for use in restoring the authentic protected data file. For example, the authentic protected data file may be compressed to change its length, encrypted to change its content and stored in a location(s) with a different name(s), designed to prevent an unauthorized user from discovering its identify or location. The file may be disassembled into separate parts with the separate parts stored separately in separate locations with different file names or left intact and stored intact. The camouflaged authentic backup file represents the data in the authentic protected data file as of the last authorized change and with the authorized protected data file attributes, for example, data length or size, data protocol or order, file name(s) or location(s), changed so the relationship between the authorized protected data file and its camouflaged authentic backup is hidden.

In the process of the translation of the authorized protected data file to the camouflaged authentic backup file, the indica representing the translation and which may be used to reconstruct the authorized protected data file, is stored in a recovery data group in an active or RAM memory of the data processor. This stored indica is accessed and used to locate and translate the authentic backup file to reconstruct the authorized protected data backup file and restore the current protected data file to the authorized protected data file. As would be known to those skilled in the art, active or RAM memory is understood as the data store accessed directly by the data processor for its logical operations, while static or disk store is the data store where data is saved from active memory or accessed and moved to active memory. Saving the recovery indicia in active or RAM memory rather than in a static or disk memory, enhances the camouflaging of the authentic backup file, as the process for identifying RAM locations and data is a different and more difficult process than location data files stored in a static or disk store. In this way the recovery file itself and its location is camouflaged and its camouflaging may be enhanced and hidden from an intruder by any of the translation techniques known to those skilled in the art. As would be understood by those skilled in the art, the invention or the inventive principles may be practiced and applied using static memory for the recovery indicia or using active memory for the authentic backup file or using a hybrid of active and static memory.

Where a comparison of the identifier produced from the authorized protected data file with the test identifier produced from the current protected data file produces an indication the current protected data file was modified from the authorized protected data file without authority, the next authorized use of the current protected data file can proceed with the restoration of the authorized protected data file translated from the authentic data backup file. The restoration process is by accessing the recovery data group stored in addressable active memory locations and using that indicia to reverse the process used to translate the authorized protected data file to the authentic backup file and to reconstruct the authorized protected file from the backup and deleting the current protected file and writing or overwriting the reconstructed authorized protected data file in its location. In this way, a current protected file may be restored to its authorized state after it has been compromised by an unauthorized modification or by an intruder into the protected data system.

Reconstructing the authorized current file from the authentic backup and restoring the protected file to its authorized state, may be accomplished according to the inventive principles, by reversing the process used to camouflage the protected file, as stated above, using the camouflaging indica saved in the recovery data group. The current protected file may be monitored automatically, according to a schedule or by sensed event, for example whenever the file is be accessed to determine if the current file contains the same information as the authentic backup file.

The invention according to the inventive principles disclosed herein, may be practiced with a data processing system employing one or more data processors. For example, a separate dedicated processor may be used, using the same active memory as the central processor or using its own dedicated memory. An expert system program may be employed as a software program or as a stored program within the processor, to operate the data processor according to the disclosed invention. Expert systems functioning by logic rules written by the user, for example may be used to schedule monitoring of the current protected data file by time or sensed event or to respond whenever a comparison of the identifier for the authorized protected data file and the test identifier for the current protected data file, indicate an unauthorized change to the authorized protected data file.

The process of recovery of the authentic protected data file and its restoration starts with the access of the recovery data group from the active memory and the recovery indicia representing the camouflaged authentic backup file. The recovery indica is used to reverse the camouflaging process as for example to decrypt and decompress the authentic backup file and to reconstruct the authentic protected backup file for writing into or overwriting, the current protected data file location. Other camouflaging techniques can be used within the invention and inventive principles as disclosed, without departing from the principles of the invention.

The means or steps describing the invention or the inventive principles may be practiced by the elements disclosed preferred embodiment or by their equivalents know now or which become known to those skilled in the art.

### BRIEF DESCRIPTION OF THE DRAWINGS

FIG. 1 shows in a block diagram, a data processing system as would be known to those skilled in the art, having a central processor, one or more active or RAM memories, one or more static data stores such as disk data storage, and a data transmission system for transmitting data internally within the system and for connection to network transmission systems for transmission and reception of data to or from other data processing systems and an intelligent agent processing system.

FIG. 2 shows in a block diagram the system elements and the process for protecting an authorized protected file by constructing and camouflaging an authentic backup file according to the principles of the invention and as would be operated by means of a general purpose computer as shown in FIG. 1.

FIG. 3 shows in a block diagram the monitoring of the current protected file as shown with regard to FIG. 1, to determine or detect any unauthorized modifications to the protected file.

FIG. 4 shows in a block diagram the recovery of the authorized protected file from the camouflaged authentic backup file produced as shown with regard to FIG. 1, when the monitoring process as shown in FIG. 3 indicates a current protected file has been compromised and it is to be restored to its authorized copy by addressing the camouflaged location of the authentic backup and using the indicia in the recovery address group to reverse the camouflaging process to reconstruct the authorized protected file in its original or authorized current state.

FIG. 5 shows in a flow chart the process according to the inventive principles for the initial setup and camouflaging of the authentic backup file and the recovery indicia.

FIG. 6 shows in a flow chart the process according to the inventive principles for monitoring the protected file to determine if the protected file has been compromised by modification without authorization and for initiating the restoration of the protected file from the authentic backup file.

FIG. 7 shows in a flow chart the process according to the inventive principles for restoring the protected file from the authentic backup file by use of the recovery indica from the recovery address group to reverse the process used to camouflage the backup file and to write the restored file into the protected file location.

FIG. 8 shows in block form examples of media and media readers which may be used to store and access a computer program for use in a data processing system for making an authentic backup file from an authorized protected data file, according to the disclosed inventive principles.

### DETAILED DESCRIPTION OF THE INVENTION

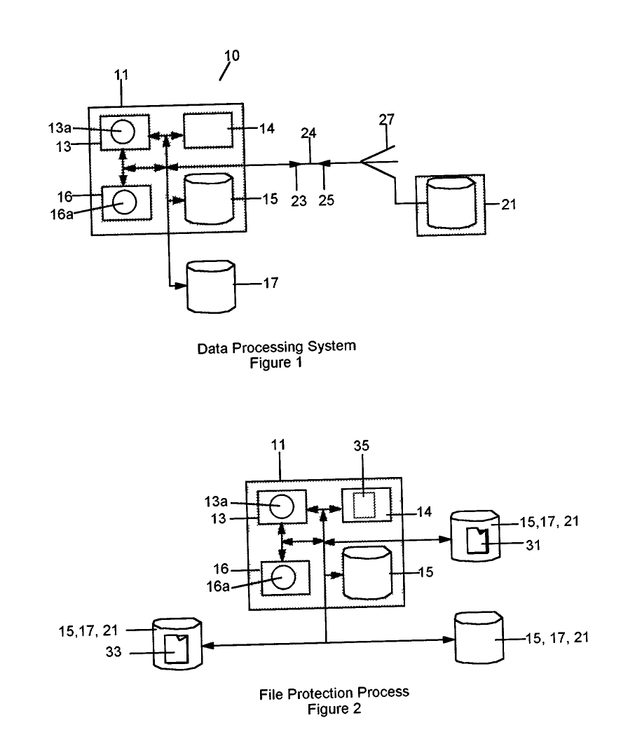

For this description of the invention, the protected data file is called the authorized protected data file when the protected data file is the original protected data file or the original protected data file modified or accessed by an authorized modification or user. In the description of the invention, the protected data file is called the current protected data file when it is monitored on a time or event driven or other basis as would be now or later known by those skilled in the art, for a representative comparison with the authorized protected data file to determine if the current protected data file has been changed from the authorized protected data file or when a change has occurred and it is not known if a change or access of a protected data file has been an authorized change or access by an authorized user. The invention as shown, according to its inventive principles, as described herein, may be used with any general data processor or network connected data processor of any kind as known or as may be known in the future, and used for processing data, the requirements being only to be able to store and retrieve data and to process information in the form of data, regardless of the means or media for representing, storing or processing, the data. An example of such a system as well known to those skilled in the art and not disclosed in detail and as may be used in the preferred embodiment according to the disclosed inventive principles is shown by numeral 10 in FIG. 1 where a general data processor 11 is shown as including a processor 13 with an active or dynamic memory or RAM 14 for storing instructions and data for processing by the processor 13, as would be known to those skilled in the art. The processor may include an expert system program 13a operated by the processor 13, or may include an expert system program 16a, in a separate dedicated processor 16 having its own embedded active memory (not shown but as would be understood by those skilled in the art). The data processor 11 is operated to translate one or more protected files resident in disk store 15 within the general data processor 11 or external to it as shown by external disk store 17 or network external disk store or server 21, all shown by way of example and not in limitation of the inventive principles. Disk store 15 or 17 or server 21, shown by way of example only, may be a hard or floppy disk or any other type of suitable data store used for the static memory for storage of data or programs for access by the processor 13, 16, and placement in active memory 14, for operation by the data system 11, or may be a combined active and static memory or may be exclusively be an active memory, as would be known to those skilled in the art now or as may be known in the future and the system 10 may be operated by any present or future means for processing data, including but not limited to electrical, magnetic, optical or biological or organic devices. Data processor 13, 16, may use an operating system, stored in the static storage 15, 17, 21, for access and placement in the active memory 14 for use by the processor 13, 16, for the data instruction and data transfer operations of data processor 11, as would be known to those skilled in the art. The programs 13a or 16a, used in processor 13 or in the separate dedicated processor 16, respectively, may be stored in the respective memories of the processors 13, 16 or in the active memory 14 or static memories 15 or 17 or server 21 and accessed or read for use by the processors through a two way data transmission system or network 27 connected by transmission line 24 and two way arrows 23 and 25, as would be known to those skilled in the art and for that reason not described in detail herein. The data processor 11 may be connected to one or more data storage devices such as server 21 through a data network shown as 27. Any kind of data transmission and storage may be used to practice this invention as disclosed herein and according to its inventive principles, as would be known or in the future known to those skilled in the art.

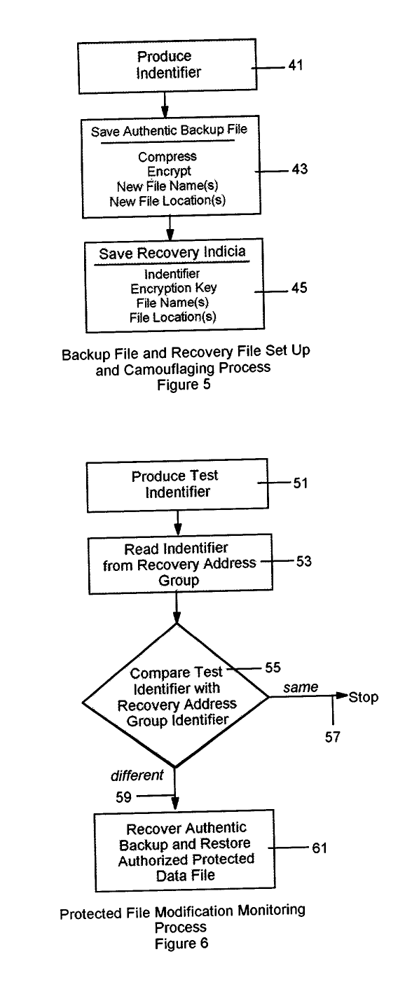

The part of system 10 as shown in FIG. 1 for operating the inventive process is as shown in FIGS. 2, 3 and 4. In FIGS. 2, 3 and 4, the interchangeable processors 13 and 16, active memory 14 representing a separate memory or representing interchangeable active memory within processors 13 or 16 as would be known by those skilled in the art and for that reason not disclosed in detail and interchangeable static storage devices 15, 17 and 21, as shown in FIG. 2, show the invention may be practiced without limitation to any particular processor or storage device. As in any data processing system, a protected file 31 stored in a data storage device, such as data stores 15, 17, or 21 may be designated as an authorized protected data file in its original state or in its then modified and authorized current state. To protect the integrity of the authorized protected data files data contents, an authentic backup file 33 is constructed and its location and identity camouflaged to remove any direct relation between any of the attributes of the authorized protected data file and the corresponding authentic backup file. In its camouflaged state the authentic backup file 33 is maintained for later use in restoration of the authorized protected data file 31, in the event of a system intrusion, such as by an intruder in the system or by unauthorized access or modification of the authorized protected file. The method of creating an authentic backup file 33 for maintaining the authorized protected data file's 31 integrity is as shown in FIGS. 2 to 7, with FIGS. 2 to 4 showing in block form the system for initiating the protection of an authorized protected data file, monitoring the protected data file and restoring the protected data file and with FIGS. 5 to 7 showing the process for initiating the protection of an authorized protected data file, monitoring the protected data file and restoring the protected data file, with the numerals referring to the process steps in FIGS. 5 to 7, shown in parentheses ( ).

According to the inventive principles, the central processor 13 or 16, shown in FIGS. 2, may be used to produce an identifier as shown by step (41) in FIG. 5 related to one or more attributes of data in the authorized protected data file and according to an algorithm such as for example, a hash algorithm or other suitable algorithm for producing such an identifier as known to those skilled in the art. As shown in FIGS. 2 and 5, the camouflaging process used in translation of the authorized protected file 31 to the saved authentic backup file 33, may use compression to change the data length, encryption by symmetric or asymmetric keys as would be known to those skilled in the art, and a change in file name and location, as shown by step (43) in FIG. 5, for storage as a camouflaged file in the storage devices 15, 17, 21 for example. By compression the relationship of size between the authentic backup file 33 and authorized protected data file 31 is changed. By encryption, the relationship of data content between the authentic backup file 33 and the authorized protected data file 31 is changed. By changing the authentic backup file 33 location(s) and name(s), the space relation between the authorized protected data file 31 and the authentic backup file 33 is changed. Changing or removing any relationships between the authentic backup file 33 and the authorized protected data file 31 serves to camouflage the authentic backup file 33 so any intrusion or unauthorized modification of the authorized protected data file 31, causing its compromise, will be preventing from extending to the discovery of the location or identity of the authentic backup file 33.

To add to the camouflage of the backup file, the recovery indica, including the identifier produced in step (41) shown in FIG. 2, and representing the translation of the authorized protected data file to the authentic backup file is saved in a recovery address group 35 in the active memory 14, shown in FIG. 2, and as step (45) in FIG. 5. The recovery indicia saved as a recovery address group may be suitably camouflaged to hide its identity and location so any unauthorized user of the data system 10 would not be able to discover the location or contents of the recovery address group and use it to access and recover the authentic backup file. Accordingly, the indica representing that authorized protected data file translation to an authentic backup file is stored (45) in a recovery address group in active memory, such as active memory 14, with the identifier, the key for decrypting the encrypted authentic backup file 33, the file name and location of the authentic backup file 33 and the indicia used for decompressing the authentic backup file and restoring it to the same length as the authorized protected data file. In the process of camouflaging the authentic backup file, the file may be separated into parts and placed in different data files and data file locations. The process of separation may be accomplished by an expert system or other suitable method as would be known to those skilled in the art, so the relationship between the identity of the authentic backup file and its separated locations may be hidden.

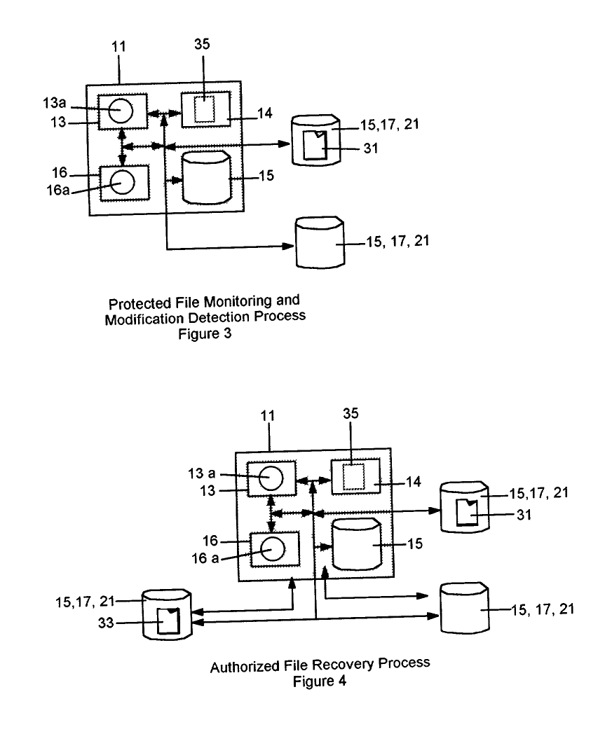

The monitoring process and system, as shown and described with reference to FIGS. 3 and 6, uses the identifier stored in the recovery address group and a test identifier produced from the current protected data file to determine if the current protected data file used to produce the test identifier is the same as the authorized protected data file. As shown in FIG. 4 and FIG. 6, the processor 13, 16, as scheduled or responsive to a sensed event, as described above, produces a test identifier (51). The identifier stored in the recovery address group 35 in the active memory 14 is accessed (53) and the test identifier and identifier are compared (55). However, as would be apparent to those skilled in the art, any other suitable system may be used to compare the authorized protected data file with the current protected data file.

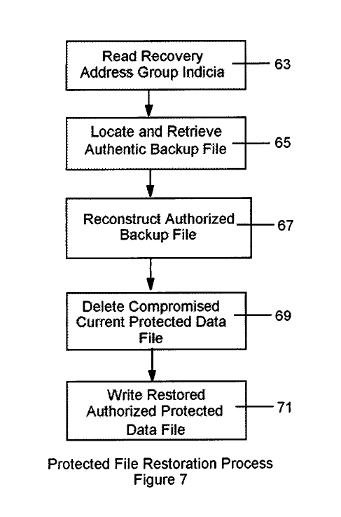

Although not shown or described, the identifier, saved in recovery address group 35 may be reproduced for the authorized protected data file 31, on a schedule or responsive to a sensed event, arranged by logical rules established within an expert system, as would be known to those skilled in the art. The identifier from recovery address group 35, is compared (55) with the test identifier produced by the processor 14, 16 from the current protected data file (51) to determine if the authorized protected data file 31 was changed without authorization (55). For example, a correspondence (57) between the identifier stored in the recovery address group 35, created when the authentic backup file was created from the protected file and the test identifier produced (51) for the current protected data file, indicates the protected file has not changed since the last authorized modification. If there is no such correspondence but a difference (59) then unauthorized tampering or modification of the protected file is indicated and responsive to that indication, the processor 14, 16, recovers (61) the indicia stored in recovery address group 35, recovers the authentic backup file 33, and reconstructs the last authorized copy of the protected file and writes the restored file into the protected file, as shown with reference to FIGS. 4 and 7.

The system and process for restoring the protected file in the event of an unauthorized modification is as shown and described with reference to FIG. 4 and FIG. 7. As described above, in the monitoring process, the protected file monitored is called the current protected data file as the purpose of the monitoring process is to determine if the current protected data file is the same or different from the authorized protected data file and the numeral 31 is used interchangeably for the authorized protected data file and the current protected data file and relative to the point in the process when the identifier is produced for the authorized protected data file or the test identifier is produced for the current protected data file. As shown with reference to FIGS. 3 and 6, an indication of an unauthorized modification of the current protected file 31 is produced where the comparison of the identifier produced from the authorized protected data file 31 with the test identifier produced from the current protected data file 31 indicates a difference and a difference in the data within these two respective files. At the time such an indication of an unauthorized modification is produced, the current protected data file 31 no longer has any integrity and the process for replacing the current protected data file 31 with an authorized protected data file copy reconstructed from the authentic backup file 33, is initiated. The process may start in the reverse order for translating the camouflaged authentic backup file 33 from the authorized protected data file 31, as disclosed in FIGS. 2 and 5. Upon the indication (59), of a difference between the identifier stored in the recovery data group 35 in active memory 14 for the authorized protected data file 31, with the test identifier produced for the current protected file, the processor 13, 16, accesses and reads (63) the recovery indica from the recovery address group 35 and representing the camouflaged authentic backup file 35 and uses that indica to locate and retrieve (65) the authentic backup file 33, file, decrypt it using the stored decryption key and decompress it, deleting the compressed file and using the authentic data backup file to reconstructed authorized protected data file 31, (69) and to write it to the current protected data file 31, (71) to restore the current protected data file with the reconstructed copy, of the authorized protected data file 31 as it was in its last authorized data state and stored as the authentic backup file 33.

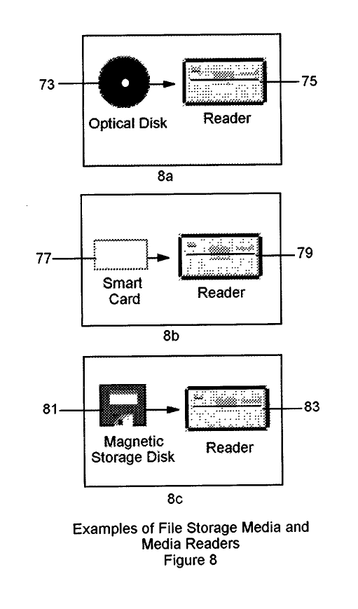

The program for creating an authentic backup file and using it in a data process such as the system 10 shown in FIG. 1 and according to the system and method as shown in FIGS. 2 to 7, as described above and according to the disclosed inventive principles, may be stored on a magnetic disk, optical disk, chip, smart card or other transportable storage medium capable of storing data, for use in a compatible data processor, and operating a data processor to perform the inventive method. An example of such magnetic storage disk 81, or optical disk 73, or smart card 77, media and the respective devices 83, 75 and 79, for reading the information on the media, as would be known to those skilled in the art, are shown in FIG. 8.

As would be understood by those skilled in the art, the invention may be practiced according to the disclosed inventive principles using any suitable apparatus now known or developed in the future,

I claim as my invention the following:

1. In a data processor, a system for making an authentic backup file from an authorized protected data file, with the data in said authentic backup file translated from said authorized protected data file to camouflage the source or identity of said authentic backup file or its relationship with said authorized protected data file and with indicia produced by said translation representing said translation, stored in a recovery address group for comparison with a test identifier produced from the current protected data file to determine if the current protected data file is the same or different from the authorized protected data file and for access and use of said recovery address group for translation of said authentic backup file to said authorized data file and restoration of said authorized protected file, comprising,
a) means for translation of an authorized protected data file to an authentic backup file, camouflaged to hide its relationship to said authorized protected data file, and for storing said authentic backup file;
b) means for producing an identifier from aid authorized protected data file and for storing said identifier;
c) means for producing a test identifier from a current protected data file for comparison with said identifier for determining if said current protected file is the same or is different from said authorized protected data file; and
d) means responsive to said comparison for translating said authentic backup file to said authorized protected data file for restoring said authorized protected file.

2. The system of claim 1, comprising,
e) means responsive to said translation of said authorized protected data file, and for producing indicia representing said translation and for storing said indicia in a recovery address group.

3. The system of claim 2, comprising
f) means for accessing said indicia from said recovery data group, and
g) means for using said indicia for translation of said authentic data file to said authorized protected data file.

4. The system of claim 1, wherein, said means for producing an identifier comprises,
h) means for producing said identifier from at least one attribute of said authorized protected data file.

5. The system of claim 4, wherein,
i) said at least one attribute is unique for said authorized protected data file.

6. The system of claim 1, wherein,
j) means responsive to said comparison for producing an indication of an unauthorized change to said authorized protected data file.

7. The system of claim 1, wherein,
k) said means for translation includes means for compression or encrypting of said authorized protected data file and producing indica representing said respective compression or encryption .

8. The system of claim 7, comprising,
l) means for storing said indicia in a recovery address group in an active memory.

9. The system of claim 1, wherein,
n) said means for translation includes means for creating a new file name or file location for said authentic backup file and storing said new file name or location in a recovery address group.

10. The system of claim 1, comprising,
o) means for producing indicia representing said translation of said authorized protected data file, and for storing said indicia in a recovery address group in active memory.

11. A system for restoring an authorized protected data file from an authentic backup file, comprising,
a) means for making an authentic backup file from an authorized protected data file;
b) means for monitoring a current protected data file for a change in said current protected file and for making a new authentic backup file in response to an authorized change to said current protected data file;
c) said means for monitoring including means for restoring said authorized protected data file with said authentic backup file in response to an unauthorized change to said current protected data file.

12. The system of claim 11, wherein,
d) said means for making an authentic backup file includes means for camouflaging the identity of said authentic backup file by translation of said authorized protected data file.

13. The system of claim 11, wherein,
e) said means for making an authentic backup file includes means for translating said authorized protected file to said authentic backup file and for producing indicia representing said translation.

14. The system of claim 13, wherein, said means for storing said indica includes means for storing said indicia in a recovery address group in an active memory.

15. The system of claim 14, wherein said means for restoring said authorized protected data file includes means for accessing and using said indicia for translating said data from said authentic backup file to said authorized protected data file.

16. The system of claim 13, wherein, said means for making said authentic backup file includes means to camouflage identity of said authorized backup file.

17. The system of claim 11, wherein,
said means for making an authentic backup file from an authorized protected data file includes,
means for producing an identifier from said authorized protected data file;
said means for monitoring the current protected data file for a change in said current
protected file includes means for producing a test identifier for comparison with said identifier;
means for comparison of said identifier with said test identifier; and
said means for restoring said authorized protected data file with said authentic backup file, restoring said authorized protected data file in response to said means for comparison indicating an unauthorized change to said current protected data file.

18. A computer program recorded on a medium for use in a data processing system, comprising,
a) means for translating an authorized protected data file into an authentic backup file;
b) means for producing an identifier for said authorized protected data file;
c) means for producing a test identifier for a current protected data file;
d) means for comparing said test identifier with said identifier;
e) means responsive to a said comparison for translating said authentic backup file into said authorized protected data file and for restoring said current protected data file with said authorized protected data file.

19. The system of claim 18, wherein,
f) said means for translating an authorized protected data file into an authentic backup file includes means to camouflage the identify of said authentic backup file.

20. The system of claim 19, wherein,
g) said means for making an authentic backup file includes means for producing indica representing said translation of at least some of the data in said authorized protected data file and for storing said indica.

21. The system of claim 20, wherein, said means for storing said indica includes means for storing said indicia in a recovery address group in an active memory.

22. The system of claim 20, wherein said means for restoring said authorized protected data file includes means for accessing and using said indicia for translating said data from said authentic backup file to said authorized protected data file.

23. The system of claim 19, wherein, said means to camouflage the identify of said backup file includes means for changing the relationship between said authorized protected data file and said authentic backup file.

24. The system of claim 18, wherein,
said means for producing a test identifier includes means for monitoring said current protected data file and producing said test identifier in response to a sensing time or an event.

25. A data processing system, comprising,
a data processor;
an active memory;
a static memory;
an operating system for transferring data to or from said active memory, said data processor or said static memory, for data processing or storage;
a program stored in said active or static memory;
said data processor responsive to said program for translating an authorized protected data file into a camouflaged authentic backup file;
said data processor responsive to said program for comparing said authorized protected data file with a current protected data file and producing an indication of a change in said current protected data file relative to said authorized protected data file; and said data processor responsive to said indication of a change for reconstructing said authorized protected data file from said camouflaged authentic backup file and restoring said authorized protected data file.

26. A method for restoring an authorized protected data file from an authentic backup file, comprising the steps of,
a) the step of making an authentic backup file from an authorized protected data file;
b) the step of monitoring the current protected data file for a change in said current protected file and making a new authentic backup file in response to an authorized change to said current protected data file or producing an indication of an unauthorized change made in said current protected data file; and
c) the step of restoring said authorized protected data file with said authentic backup file in response to said indication of an unauthorized change made in said current protected data file.

27. The method claim 26, wherein,
d) said step of making an authentic backup file includes the step of camouflaging the identity of said authentic backup file by translation of said authorized protected data file.

28. The method of claim 27, wherein,
e) said step of making an authentic backup file includes the step of producing indica representing said translation of the data in said authorized protected data file into said authentic backup file and the step of storing said indica.

29. The method of claim 28, including,
the step of storing said indica in a recovery address group in an active memory.

30. The method of claim 26, wherein said step of restoring said authorized protected data file includes the step of accessing and using said indicia for translating said data from said authentic backup file to said authorized protected data file.

31. The method of claim 26, wherein, said step of making said authentic backup file includes the step of camouflaging the identify of said authentic backup file.
